(19) United States
(12) Patent Application Publication
(10) Pub. No.: US 2007/0271221 A1
(43) Pub. Date: Nov. 22, 2007

(54) SECURING SOCIAL SECURITY NUMBERS WITH PINS

(75) Inventors: Brian R. Gephart, South Jordan, UT (US); Michael F. Dobson, South Jordan, UT (US); Bradley W. Mitchell, Cottage Grove, MN (US)

Correspondence Address: WORKMAN NYDEGGER, 60 EAST SOUTH TEMPLE, 1000 EAGLE GATE TOWER, SALT LAKE CITY, UT, 84111, US

(73) Assignee: TRANSACTIONSECURE LLC, Centerville, UT (US)

(21) Appl. No.: 11/749,403

(22) Filed: May 16, 2007

Related U.S. Application Data
(60) Provisional application No. 60/747,381, filed on May 16, 2006.

(51) Int. Cl. G06F 17/30

(52) U.S. Cl. 707/2

(57) ABSTRACT

Systems and methods for securing a social security number involve pairing a traditional personal identification number, or other personal identifier, with a social security number for verification purposes. In particular, the owner of the social security number can link a PIN, or other identifier, to their social security number in a data storage system. If the owner of a social security number is required to verify their identity, the institution requiring the identity verification can request from the user and submit the person's PIN, or other personal information, to a third-party granting system (e.g., trusted entity), in order to verify that it is paired with the social security number. If the PIN matches the social security number/PIN pairing in the data storage system, the institution can be notified that the individual is verified, and/or indeed owns the social security number.

### CROSS-REFERENCE TO RELATED APPLICATIONS

The present invention claims the benefit of priority to U.S. Provisional Patent Application No. 60/747,381, filed on May 16, 2006, entitled “Securing Social Security Numbers with PINS,” the entire contents of which are incorporated herein by reference.

### BACKGROUND

1. The Field of the Invention

Implementations of the present invention relate to systems for securing sensitive numbers with secondary information, such as one or more Personal Identification Numbers.

2. Background and Relevant Art

As computerized systems have increased in popularity, so have the needs to secure information used therewith. One way access to certain types of information has been secured in the past is through a user providing a social security number as part of a verification process. Upon providing the social security number, the user might then be granted access to a wide range of personal information, such as bank account information, grade information at a college, or the like. Unfortunately, if another person were to steal the social security number, the thief might be able to impersonate the user and obtain access to the sensitive personal information. This is generally because someone presenting a social security number is not always required to provide supporting documentation to show ownership of the social security number. As a result, people are often reticent to use their social security number for obtaining accounts and/or for continuing to use them as a verification means, even though they may always be associated with the social security number.

More recently, a number of states are now forbidding schools from using social security numbers as a primary identifier. For example, the states prohibit their public and/or private school systems from use of social security numbers, or otherwise might require an “opt out” exclusion. In addition, some states even include rules regarding the electronic transmission of social security numbers.

In addition these and other states may further limit the usage of social security numbers with additional laws. For example, some states have considered legislation that would allow consumers to “freeze” credit reporting by the bureaus, while these and other states have proposed that a user can restrict posting and printing of social security numbers altogether. In addition, the some states have proposed legislation proposing requirements to notify a customer of security breeches. Along these lines, some states even have proposed legislation designed to prevent government agencies from incorporating social security numbers into licenses, permits, passes, or the like. Furthermore, some states require personal data to be destroyed in a wide range of cases, whether paper or electronic, and institute a wide range of commercial penalties for failing to do so.

In addition to these state-based efforts, groups such as the Electronic Privacy Information Center (“EPIC”) have made a number of security recommendations regarding social security numbers. In particular, the EPIC has proposed limiting the use of social security numbers to those circumstances where use is explicitly authorized by law. For example, an employer may be permitted to ask an employee for an SSN for tax-reporting purposes (as long as the SSN remains the Taxpayer Identification Number), but a health club may not be permitted to ask a customer for an SSN as a condition of membership. In addition, the EPIC has recommended prohibiting the sale (and display) of social security numbers by government agencies, since it may be inconsistent with Section 7 of the Privacy Act to allow the federal government to disseminate social security numbers in the first place.

Furthermore, EPIC has recommended preventing companies from compelling consumers to disclose their social security numbers as a condition of service or sale, unless there is a statutory basis for the request. EPIC has also recommended penalizing the fraudulent use of another person's social security number, but not the use of a social security number that is not associated with an actual individual. This could permit, for example, a person to provide a number such as “123-00-6789” where there is no intent to commit fraud. The EPIC has further encouraged the development of alternative, less intrusive means of identification.

A number of these legislative efforts and recommendations are based on a number of well-known existing privacy problems. Recently, for example, a number of large institutions have been sued for potential data loss affecting hundreds of thousands of people due to putative privacy breaches. To fight such liabilities, a number of companies are beginning to force the customer to waive rights to sue if they lose customer data. This is, perhaps, not surprising since organizations recognize the wide potential of liability for even one person to recover from identity theft, if not hundreds of thousands of people. For example, some organizations estimate that it can take the average person potentially tens to hundreds of hours and hundreds of dollars to repair the mess caused by an instance of identity theft. Under current federal and state laws, individuals may nevertheless have little recourse to seek damages for their losses.

Besides the mere fact that social security number usage can pose significant privacy loss risks, there are many ways in which social security numbers can be intercepted. For example, an outside hacker may gain access to a computer and access to social security data. Similarly, unauthorized employees or contractors might be able to access such information through internal database usage and access. Furthermore, printed materials and reports within an organization often contain social security information. Still further, backup data from a computer system often contains social security data if it was contained on the computer being backed up. Yet still further, social security data access may be obtained simply through accidental outside access, such as a view of computer screen through a window, overhearing a conversation with a banking teller, and so forth.

Accordingly, there are a number of difficulties associated with securing social security number usage.

### BRIEF SUMMARY

Implementations of the present invention provide systems, methods, and computer program products configured to pair a secondary identification information, such as a traditional personal identification number (“PIN”), with a social security number for verifying that an individual is the owner of the social security number. In particular, the owner of the social security number can link a PIN, or other identifier, to their social security number in a data storage system as a linked association of data. If the owner of a social security number is required to verify their identity, the institution requiring the identity verification can request that the individual submit their PIN, or other personal information, in order to verify that the secondary identification information is paired with the social security number. If the PIN matches the linked association in the data storage system, the institution can be notified that the identity of the individual is valid, and/or that the individual indeed owns the social security number(s).

Accordingly, at least one implementation of the present invention relates generally to a computer system and/or data storage system for storing social security number pairing with one or more personal identifiers, such as a traditional plural digit PIN. In general, paired data can include a PIN, a password, an answer to a question, biometric data, and/or a digital photo. For example, the computerized system(s) can set up a social security number/PIN pairing with the social security number, and values associated with addresses, birthdays, and so forth. The computer system can then receive a request to authorize data access based on a social security number, and can then request additional paired information. The user can then supply the PIN (or other identifiers) through any one or more electronic interfaces, including internet and telephone voice interfaces to thus prove ownership of the social security number.

In addition, at least one implementation of the present invention relates to a method or system for linking the social security number and personal identifiers. The method involves any one or more acts for receiving submitted personal data and social security information. In addition, the method can involve verifying through one or more database checks that the social security number and provided personal identification information are both valid and appropriately linked together. Furthermore, the method can then involve providing a corresponding response, such as that the access is approved or not approved, or that further information may need to be provided.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an overview schematic diagram in accordance with an implementation of the present invention in which a user secures a social security number with a trusted entity, and verifies ownership of the social security number with a different account entity;

FIG. 2 illustrates an overview flowchart in accordance with an implementation of the present invention for receiving and storing a linked association between social security numbers and personal identifiers; and

FIG. 3 illustrates an overview flowchart in accordance with an implementation of the present invention for verifying ownership of a social security number through comparison of additionally received information with a linked association for the social security number.

### DETAILED DESCRIPTION

Implementations of the present invention extend to systems, methods, and computer program products configured to pair a secondary identification information, such as a traditional personal identification number (“PIN”), with a social security number for verifying that an individual is the owner of the social security number. In particular, the owner of the social security number can link a PIN, or other identifier, to their social security number in a data storage system as a linked association of data. If the owner of a social security number is required to verify their identity, the institution requiring the identity verification can request that the individual submit their PIN, or other personal information, in order to verify that the secondary identification information is paired with the social security number. If the PIN matches the linked association in the data storage system, the institution can be notified that the identity of the individual is valid, and/or that the individual indeed owns the social security number(s).

As will be appreciated more fully herein, implementations of the present invention include a number of components and mechanisms for securely storing as well as verifying social security number associations. In one implementation, for example, a computer system includes hardware and software in a data storage system (e.g., a secure database), and is configured generally for storing social security number pairing with secondary information, such as a PIN or other personal data. For example, a computer system can perform steps for receiving one or more social security numbers and storing the social security number.

The computer system can also be configured to store a linked association of the social security number with data that is at least intended to be paired with a PIN. One will appreciate, of course, that this may or may not be the same computer system, for added security benefits.

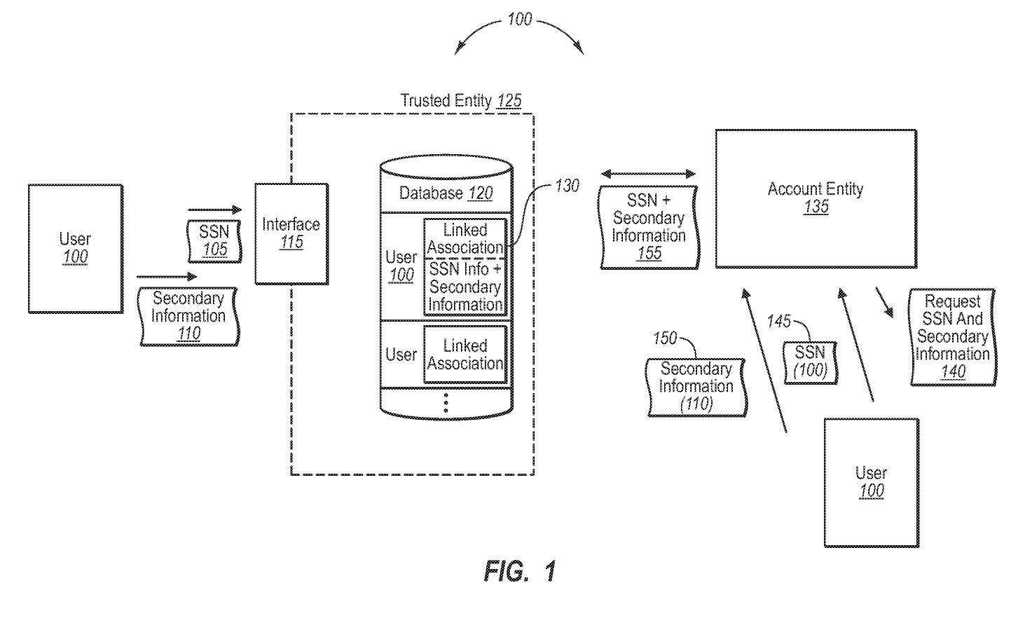

Referring now to the Figures, FIG. 1 illustrates an overview schematic diagram in which a user secures a social security number with a trusted entity, and verifies ownership of the social security number with a different account entity. For example, FIG. 1 shows that a social security securing system 100 comprises at least a trusted entity 125 with which a user 100 creates a linked association between a social security number and other secondary information. In particular, FIG. 1 shows that user 100 provides or sends social security number 105 to trusted entity 125 through user interface 115. For example, interface 115 is a terminal at a bank, or web-enabled user interface into which a user logs-in to some other securing entity from a home location.

FIG. 1 also shows that the user provides secondary information 110 through interface 115. For example, user 100 provides a PIN of any length (e.g., 4, 5, 6, digits, etc.) through interface 115. Alternatively, user 100 provides biometric data through interface 115 such as a biometric reader at the trusted entity 125, or via a connection at the user's home computer. In addition, and as also discussed herein, the user might alternatively provide other challenge information to the trusted entity 125 through interface 115, thereby adding yet another layer of security to the access of social security number 105.

FIG. 1 also shows that trusted entity 125 can then take this information 105, 110 and create a linked association 130 in database 120. For example, trusted entity 125 comprises any number of secure databases 120 which comprise records specifically configured for maintaining social security numbers in a secure fashion. Alternatively, database 120 is another account database at entity 125, and the social security number and secondary information 110 (e.g., a PIN) are simply added to the records also stored for user 100. In any event, trusted entity 125 stores linked association 130 as one or more records, and provides access to the records only upon receiving the appropriate information from another requesting entity.

For example, FIG. 1 shows that user 100 is also interfacing with account entity 135. Account entity 135 may comprise, for example, a local gym or club where access to the entity is provided only through proper social security verification information. Similarly, entity 135 may be a school or government entity that requires verification of a social security number before creating an academic account of some sort. In any event, FIG. 1 shows that user sends social security number 145 in response to request 140 for a social security number and secondary information. Although request 140 is shown as a single message, one will appreciate that this information can be sent as multiple requests and corresponding challenges.

In particular, FIG. 1 also shows that user 100 sends in a separate message secondary information 150. For example, in response to receipt of social security number 145, account entity 135 is either automatically configured to challenge the validity of the social security number, or recognizes that the social security number requires authentication before processing. In particular, the account entity 135 may identify from a portion of the number that the social security number is associated with a state or other entity that requires validation, or that the user has requested that the social security number only be used with a challenge to its validity, and entity 135 identifies this fact from an internal or external database.

In any event, FIG. 1 shows that user 100 sends social security number 100 in message 145 to account entity 135 along with secondary information 150. For example, in addition to providing social security number 100, user 100 also provides secondary information 110, which includes biometric information, or a PIN, via message 150. Account entity 135 then sends this social security number information and secondary information to trusted entity 125 via message 155.

For example, account entity 135 communicates message 155 with trusted entity 125 via one or more secure communication linkages. Trusted entity 125 can then verify accuracy of the social security number to account entity 135, which then grants access to user 100. In alternative implementations, trusted entity 125 may further require additional challenges to be met by user 100, and thus send such challenge questions to account entity 135. For example, trusted entity 125 might require account entity 135 to ask additional information provided in message 110, such as the user 100 birthday, zip code, etc.

Of course, in the event that the secondary information is not provided, or the secondary information is provided, but does not match information found in the linked association 130, one or both of the trusted entity 125 or the account entity 135 can provide a report to an appropriate authority entity. For example, the trusted entity 125 can provide a report to the proper users of unauthorized access, and/or to a government body responsible for issuing social security numbers. Alternatively, the account entity 135 can provide a report to the trusted entity 125 of unauthorized access, or can provide the same or similar report to another authorization entity, such as the above-mentioned government body responsible for issuing social security numbers.

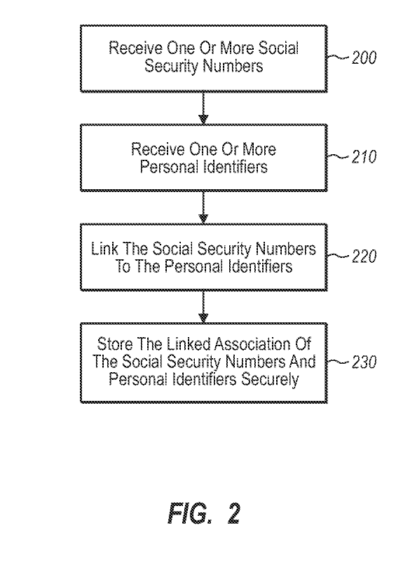

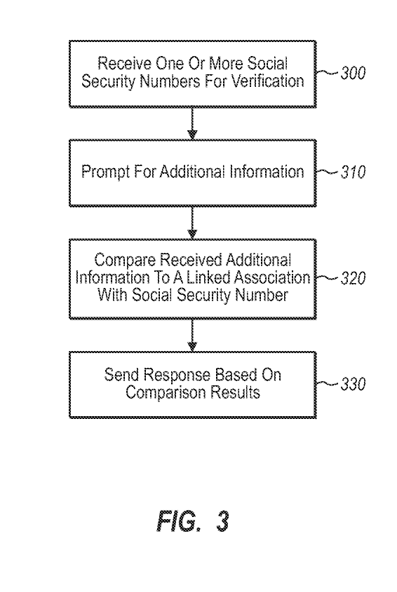

Accordingly, FIG. 1 provides a number of components in a schematic for securing information such as social security numbers using secondary information such as a PIN, biometric information, or the like. One will appreciate that implementations of the present invention can also be described in terms of flowcharts comprising one or more acts for accomplishing a particular result. The acts in FIGS. 2 and 3 are described below with respect to the components of FIG. 1.

For example, FIG. 2 shows that a method from the perspective of trusted entity 125 of securing a social security number can comprise a step 200 of receiving one or more security numbers. For example, FIG. 1 shows that the user sends or provides social security number 100 to trusted entity 125 via interface 115. As previously mentioned, this can occur by the user simply entering an office of the entity 125, or logging in via a user interface through a secure internet connection, and providing the social security number information via message 105.

FIG. 2 also shows that the method from the perspective of trusted entity 125 can comprise a step 210 for receiving one or more personal identifiers. Generally, these identifiers will be paired with a particular social security number, and can include (but are not limited to) a traditional PIN (e.g., a series of numbers), and a password (e.g., any series of alpha-numeric characters). This personal data (or “secondary information”) can further include answers to a challenge/response mechanism, such as an answer to a question about the user's (100) birthplace, mother's maiden name, etc., where the individual provides the answer to a question. The personal or secondary data/information can still further include various biometric data, such as any one or more of a finger print, an iris/retinal scan, a DNA sample, or the like. The personal/secondary information to be associated with a social security number can yet still further include a digital photo.

The trusted entity 125 can then create and store a linked association between the social security number and the secondary information. For example, FIG. 2 shows that the method can include a step 220 for linking the social security numbers to the personal identifiers numbers. In some cases, for example, the computer system may store this information in a relational database for which access is limited to a small number of administrative personnel. In other cases, the computer system may store the social security number in one database 120 with initial account information, and relate that database information to another database at another computer system on a local network that stores associated personal biometric data as part of a database server farm.

Accordingly, the method of FIG. 2 further includes a step 230 for storing the linked association of the social security numbers and the personal identifiers securely. In general, this means that verification by others of the social security number cannot be done without the requesting entity providing answers in a challenge with satisfy the secondary information component of the linked association. In other cases, this also means that such verification can only be accomplished (in addition to providing the secondary information) through secure communication protocols.

As previously mentioned, the computer system (or another computer system) can be configured to set up initial verifications for the social security number. For example, the computer system can be configured to receive initial verification, which includes, of course, the social security number, and can also include, but is not limited to, such information as a date of birth, a current or prior address, a current or prior employer address, or the like. In one implementation, trusted entity 125 is a bank teller's personal computer that is linked to a mainframe. The mainframe can thus receive the social security information and basic date of birth information and so on (e.g., via messages 105, 110, etc.) This information is then stored in the mainframe (e.g., database 120) pursuant to receiving additional personal identification information for a linked association (130).

One will appreciate that an individual can initially verify their identity and submit the PIN (or other secondary information) through any one or more of a network interface, and an Interactive Voice Response (“IVR”) and/or Voice Response Unit (“VRU”). For example, an individual can verify their identity at the financial institution when trying to set up the account in-person (or through a local network interface). The individual can also verify their identity by submitting their secondary information (PIN, biometric information) through a call center enabled with VRU/IVR for PIN or other secondary information.

In addition to the foregoing, implementations of the present invention can also include one or more methods for securely granting access to an account by requiring verification of ownership of a social security number. As shown in FIG. 3, for example, one method from the perspective of an account granting entity 135 can include a step 300 of receiving one or more social security numbers for verification. For example, a user submits their social security number as a means to obtain certain sensitive account information, and/or in response to a request (e.g., 140).

In addition, FIG. 3 shows that the method can include a step 310 for prompting the user for additional information. As previously mentioned, this may be a separate step, or even part of the same step as with step 300. In any case, FIG. 1 shows that the user might then submit a PIN or other biometric information, such as via message 150, after having provided social security number 100 via message 145.

As previously mentioned, one will appreciate that the user can submit this information (the social security number, secondary information/PIN, or both) through any appropriate transmission means, potentially secured through any appropriate secure transmission protocols (e.g., on networks—HTTPS, SSL, TSL, etc.) In addition, the individual may submit the social security and/or personal identification information in person, and/or through any one or more of a wide area network website, an IVR/VRU interface, or through a local area network website.

Upon receipt of this information from the user and/or the account granting institution, the account entity 135 (or a computer system at the entity 135) can then verify ownership of the social security number. For example, FIG. 3 shows that the method can include a step 320 for comparing received additional information to a linked association with the social security number. In particular, the account entity 135 can communicate the social security information and secondary information via one or more messages 155 to trusted entity 125 (which may or may not be the same overall entity as entity 135).

Account entity 135 can then identify if the social security number is one that is linked to a particular association (130) with personal identification information. If so linked, the account entity 135 (e.g., via trusted entity 125) can then identify if the personal information of message 155 matches what was provided in linked association 130.

The account entity 135 (e.g., via computer transmission means) can then provide a corresponding response to the user 100. For example, FIG. 3 shows that the method can further include a step 330 for sending a response based on the comparison results. This can generally include the account entity responding over the same communication means used to transmit the social security number and personal identification information in the first instance. Of course, other return transmission means may be appropriate, including any wired, wireless, or hard copy communication means. In general, the response provided by the computer system can include any one or more of bits of information including that there is a match, that there is no match, or that the verification cannot be made with the currently provided secondary information (i.e., more information may be needed to complete the comparison).

Accordingly, FIGS. 1-3 provide a number of schematics and methods for ensuring that social security numbers can be adequately secured, and can thus lead to greater prevention of identity theft, and the like. One will appreciate that the mechanisms and components described herein can be implemented without significant expense to many account granting or account storing institutions. For example, much of the communication regarding social security numbers and secondary information can be provided using computer systems at point of sale terminals, card reader terminals, automated teller machines, secure internet-enabled user interfaces, as well as the more traditional mechanisms of in-person interactions with an account-granting officer. As such, implementations of the present invention provide a number of low-cost mechanisms that can potentially save far greater amounts in identity-theft related remedies.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a trusted entity in a computerized environment in which a social security number is used as a means to verify a person's identity in order to set up one or more accounts, a method of securely storing the social security number in with a linked association to additional personal identification information, comprising the acts of:
receiving one or more social security numbers;
receiving one or more personal identifiers, wherein the one or more personal identifiers comprise secondary information for verifying the one or more social security numbers;
linking the one or more social security numbers to the one or more personal identifiers through one or more corresponding linked associations; and
storing the one or more linked associations of the one or more social security numbers and the one or more personal identifiers securely, such that ownership of the one or more social security numbers is proven by presentation of the one or more personal identifiers.

2. The method as recited in claim 1, wherein the one or more personal identifiers include a numeric personal identification number.

3. The method as recited in claim 1, wherein the one or more personal identifiers include biometric information for one or more persons corresponding to the one or more social security numbers.

4. The method as recited in claim 1, further comprising receiving the one or more social security numbers and the one or more personal identifiers via a secure network communication link.

5. The method as recited in claim 1, further comprising receiving one or more requests from an account entity requesting verification of one of the one or more social security numbers.

6. The method as recited in claim 5, further comprising identifying that the requested one social security number can only be verified with secondary information in one of the one or more linked associations.

7. The method as recited in claim 6, further comprising:
receiving one of incorrect secondary information, or an indication that the secondary information is unavailable; and
sending a response to the account entity that the requested social security number cannot be verified.

8. The method as recited in claim 6, further comprising:
receiving correct secondary information; and
sending a response that the requested social security number is verified.

9. The method as recited in claim 8, further comprising:
identifying that only part of the linked association data that is required has been provided; and
sending one or more responses to the account entity that indicate that one or more challenges that need to be met before verifying the requested social security number.

10. The method as recited in claim 9, further comprising:
receiving one or more answers to the one or more challenges; and
upon identifying that the one or more answers satisfy a remaining part of the linked association, sending one or more new responses that the requested social security number is verified.

11. At an account entity in a computerized environment in which a social security number is used as a means to set up one or more accounts, a method of verifying ownership of the social security number based on the receipt and comparison of additional personal or secondary identification information, comprising the acts of:
receiving one or more social security numbers for verification to open and/or access one or more accounts from one or more users;
prompting the one or more users for secondary identification information corresponding to the presented one or more social security numbers;
comparing the received additional information to one or more linked associations for the received one or more social security numbers; and
sending one or more responses to the one or more users based on a comparison of the received additional information to any results of the comparison.

12. The method as recited in claim 11, further comprising sending the received one or more social security numbers to a trusted entity for verification.

13. The method as recited in claim 12, further comprising receiving from the trusted entity one or more indications that the secondary identification information is required to verify the one or more social security numbers.

14. The method as recited in claim 13, further comprising providing an indication to the one or more users that the one or more social security numbers cannot be verified without additional secondary information.

15. The method as recited in claim 13, further comprising sending a new request to the trusted entity that includes the one or more social security numbers and the corresponding secondary information.

16. The method as recited in claim 15, further comprising:
receiving an indication that the corresponding secondary information is invalid; and
sending an alert to an authorization entity that an attempt has been made for unauthorized use of the one or more social security numbers.

17. At a trusted entity in a computerized environment in which a social security number is used as a means to verify a person's identity in order to set up one or more accounts, a computer program storage product comprising computer-executable instructions stored thereon that, when executed, cause one or more processors at the trusted entity to perform a method comprising:
receiving one or more social security numbers;
receiving one or more personal identifiers, wherein the one or more personal identifiers comprise secondary information for verifying the one or more social security numbers;
linking the one or more social security numbers to the one or more personal identifiers through one or more corresponding linked associations; and
storing the one or more linked associations of the one or more social security numbers and the one or more personal identifiers securely, such that ownership of the one or more social security numbers is proven by presentation of the one or more personal identifiers.
